(19) United States
(12) Patent Application Publication
(10) Pub. No.: US 2006/0220289 A1
(43) Pub. Date: Oct. 5, 2006

(54) Vibration damping device

(75) Inventors: Kei Okumura, Kakamigahara-shi (JP); Tomohiro Kanaya, Kasugai-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., Komaki-shi (JP)

(21) Appl. No.: 11/391,238

(22) Filed: Mar. 29, 2006

(30) Foreign Application Priority Data
Mar. 30, 2005 (JP) 2005-099968

(51) Int. Cl. F16F 13/00

(52) U.S. Cl. 267/140.13

(57) ABSTRACT

A vibration-damping device having a first and a second mounting member elastically connected together by means of a main rubber elastic body; a resin bracket of generally tubular shape fastened fitting externally onto said second mounting member; and a rubber stopper having a through-hole formed in its basal end portion and supported by means of an engaging recess of the resin bracket. An inside width dimension of the engaging recess is wider at a bottom side portion than an opening portion so that an anchor shaped basal end portion of the rubber stopper fits inserted within said engaging recess, and the through-hole in the basal end portion of the rubber stopper is filled with the retaining resin element.

### INCORPORATED BY REFERENCE

The disclosure of Japanese Patent Application No. 2005-099968 filed on Mar. 30, 2005 including the specification, drawings and abstract is incorporated herein by reference in its entirety.

### BACKGROUND OF THE INVENTION

1. Field of the Invention

The present invention relates generally to a vibration damping device for installation between parts to be linked in a vibration damped manner, and more particularly to the vibration damping device suitable for use as an automotive engine mount, body mount, or the like.

2. Description of the Related Art

Vibration damping devices of a design wherein a main rubber elastic body is disposed between a first mounting member and a second mounting member respectively attached to component to be linked in a vibration damping fashion are utilized in a wide range of fields. One type of known device is disclosed, for example, in JP-A-9-66721, which has a structure comprising a main rubber elastic body having generally frustoconical shape overall; a second mounting member whose tubular portion is affixed onto the outside peripheral face of the large diameter end of the main rubber elastic body; and a first mounting member affixed to the center section including the small diameter section of the main rubber elastic body, whereby the first mounting member and the second mounting member are directly elastically coupled by means of the main rubber elastic body.

This kind of vibration damping device advantageously assures sufficient volume on the part of the main rubber elastic body, and can prevent the occurrence of excessive distortion due to deformation of the outside peripheral face of the main rubber elastic body being constrained by the second mounting member. With this arrangement, in particular, there can be advantageously attained good load bearing performance and durability against load input in the direction in which the small-diameter end and the large-diameter end of the main rubber elastic body move closer to each other, and thus the implementation of such a design, for example, in an engine mount or other structure subjected to heavy initial load is under consideration.

In this kind of vibration damping device, in order to provide cushion-wise limitation of the extent of relative displacement of the first mounting member and the second mounting member occurring when excessive vibration is input, there has been proposed, for example, in U.S. Publication No. 2003-0001322 A1, a so-called bound stopper mechanism wherein a stopper rubber is disposed on the second mounting member in the portion thereof situated in opposition to an abutting fitting or the like (not shown) which is fastened to the first mounting member, so that when excessive vibration is input across the first mounting member and the second mounting member, the abutting portion of the second mounting member and the abutting fitting fastened to the first mounting member come into abutment via the stopper rubber. This makes it possible to provide cushion-wise limitation of the extent of displacement of first mounting member and the second mounting member, in the direction in which these parts move closer to one another.

U.S. Publication No. 2003-0001322 A1 also teaches that this stopper rubber is formed as a separate part from the vibration damping device and installed later on the vibration damping device. However, in order to fasten this kind of stopper rubber which is formed as a separate part to the bracket, it is sometimes necessary to provide a special fastener such as a bolt or nut, which tends to increase the number of parts required, posing the risk of increased production costs and lower productivity.

If, on the other hand, the rubber stopper is attached to the bracket by means of bonding without the use of fasteners such as bolts or nuts, impurities can become deposited on the bonding faces during assembly of the vibration damping device, resulting in some instances in insufficient bond strength. Thus, there is a risk of inability to maintain consistent quality, or in some instances difficultly in attaining consistent performance.

Where the rubber stopper is instead fastened to the mounting member on the bracket side by means of an engaging or other non-adhesive mechanism, it is difficult to securely attach the rubber stopper to the bracket, and depending on factors such as the magnitude or input direction of vibration, the assembly may be subjected to external forces in directions other than the axial direction, with the risk that the rubber stopper will come apart from the bracket, making it difficult to ensure an adequate level of reliability.

### SUMMARY OF THE INVENTION

It is therefore one object of this invention to provide a vibration damping device of novel construction, whereby the rubber stopper can be realized with a small number of parts, while at the same time making the rubber stopper readily mountable on the bracket, as well as consistently maintaining its initial state of attachment.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

A first mode of the invention provides a vibration damping device for elastically connecting two components in a vibration damping fashion, said device comprising: a first mounting member fixable to one of the two components; a second mounting member of generally tubular shape fixable to an other of the two components, the first mounting member being disposed spaced apart from a first open end of the second mounting member; a main rubber elastic body elastically connecting the first and second mounting members together; an outer bracket of generally tubular shape fastened fitting externally onto said second mounting member so that the second mounting member is mounted via said outer bracket onto the other of the two components, the outer bracket comprising a resin bracket fabricated of synthetic resin that includes: an engaging recess at a first axial end portion thereof; an integrally formed flange portion at an other axial end portion thereof with a fastener fitting for fastening the resin bracket to the second mounting member being fastened inserted within said flange portion; and a retaining resin element integrally formed therewith; and a rubber stopper having a through-hole formed in a basal end portion thereof and supported by means of said engaging recess of the resin bracket, wherein an inside width dimension of the engaging recess is wider at a bottom side portion than an opening portion so that the basal end portion of the rubber stopper fits inserted within said engaging recess, and the through-hole in the basal end portion of the rubber stopper is filled with the retaining resin element.

In the vibration damping device constructed according to this mode, the rubber stopper can be easily attached to the resin bracket by means of engaging action of the basal portion of the rubber stopper and the engaging recess formed in the resin bracket, and productivity can be improved thereby. Additionally, since there is no need for special parts to attach the rubber stopper to the resin bracket, the number of parts can be reduced, and lower production expenditures can be achieved.

The rubber stopper is easily attached non-adhesively to the resin bracket by means of engaging action of the basal portion of the rubber stopper with the engaging recess formed in the resin bracket, and the through-hole furnished in the basal end portion of the rubber stopper is filled with the retaining resin element integrally formed with the resin bracket. With this arrangement, the rubber stopper will not become dislodged from the resin bracket even when subjected to outside force acting on it produced by striking of the rubber stopper during input of excessive vibration. Accordingly, the stopper consistently maintains its initial state of attachment, making it possible to attain higher reliability.

Additionally, since the fastener fitting used to the fasten the resin bracket to the vehicle is affixed to the resin bracket by being embedded therein, it is possible to readily mount the vibration damping device on the members to be damped, and the ease of the mounting operation can be improved as well.

A second mode of the invention provide a vibration damping device according to the first mode, wherein said engaging recess is constituted by a circumferential slot that extends a prescribed length in a circumferential direction of said resin bracket; said rubber stopper has an elongated shape extending in a circumferential direction corresponding to said circumferential slot; and said through-hole and said retaining resin element are formed so as to extend in a width direction of said circumferential slot.

In the vibration damping device according to this mode, the engaging recess and the rubber stopper are formed so as to extend in the circumferential direction of the resin bracket, and the through-hole and the retaining resin element are formed so as to extend in the width direction of the engaging recess, thereby affording a high degree of freedom in setting the width dimension of the through-hole. Consequently, the through-hole can be easily and quickly filled with the retaining resin element, making it possible to advantageously achieve improved productivity. Additionally, failure to properly fill the through-hole with the retaining resin element can be effectively prevented, and more consistent quality can be attained, making it possible to attain consistent performance.

A third mode of the invention provide a vibration damping device according to the first or second mode, wherein a plurality of said through-holes and said retaining resin elements are formed in said engaging recess and said rubber stopper.

In the vibartion damping device according to this mode, the plurality of through-holes are formed, and each of this plurality of through-holes is filled with a retaining resin element, whereby the rubber stopper can more advantageously be prevented from dislodging from the resin bracket, making it possible to further improve reliability.

A fourth mode of the invention provides a vibration damping device according to any one of the first through third modes, further comprising an abutting bracket fastened to said first mounting member and extending out in an axis-perpendicular direction, wherein said first mounting member is mounted via said abutting bracket onto one of said two components, said abutting bracket having an abutting portion situated spaced apart in axial opposition with respect to the other axial end portion of said resin bracket; and said abutting portion of said abutting bracket has a bound stopper function by means of striking against said resin bracket in an axial direction via said rubber stopper.

In the vibration damping device according to this mode, by means of a bound stopper mechanism produced by the abutting portion of the abutting bracket striking the resin bracket in the axial direction via the rubber stopper disposed on the resin bracket. This makes it possible to effectively prevent excessive axial displacement of the first mounting member and the second mounting member when excessive vibration is input, resulting in excessive elastic deformation of the main rubber elastic body, so that improved durability can be achieved.

A fifth mode of the invention provides a vibration damping device according to any one of the first through fourth modes, wherein a vicinity of the opening of the engaging recess formed in the resin bracket constitutes a dislodgment preventing portion of constricted width; and said engaging portion of said rubber stopper has a shoulder portion that engages with said dislodgment preventing portion of said engaging recess.

In the vibration damping device according to this mode, a dislodgment preventing portion is formed in the engaging hole of the resin bracket, and a shoulder portion is formed on the engaging portion of the rubber stopper, whereby the rubber stopper can be securely mounted to the resin bracket by means of engaging, making it possible to more advantageously prevent the rubber stopper from becoming dislodged from the resin bracket.

A sixth mode of the invention provides a vibration damping device according to any one of the first through fifth modes, further comprising a pressure receiving chamber whose wall is partially constituted by said main rubber elastic body and adapted to give rise to pressure fluctuations when vibration is input; and an equilibrium chamber whose wall is partially constituted by a readily elastically deformable flexible film and adapted to permit change in volume when vibration is input, wherein a noncompressible fluid is sealed within said pressure receiving chamber and said equilibrium chamber, and an orifice passage is formed connecting said pressure receiving chamber and equilibrium chamber together, the device exhibiting vibration damping action on the basis of flow action of fluid through said orifice passage.

In the vibration damping device according to this mode, passive vibration damping action can be effectively obtained through vibration damping action based on flow action of fluid.

A seventh mode of the invention provides a vibration damping device according to the sixth mode, further comprising an excitation mechanism for exerting excitation force on said pressure receiving chamber.

In the vibration damping device according to this mode, dynamic vibration damping action can be effectively obtained through excitation force exerted on the pressure receiving chamber by the excitation mechanism.

As will be apparent from the preceding description, in the vibration damping device constructed according to the present invention, the rubber stopper can be readily mounted on the resin bracket with a small number of parts and without the need for fittings for fastening and the like, reduced production cost and improved productivity can be realized. The initial state of attachment of the rubber stopper to the resin bracket can be consistently maintained, so that high reliability can be ensured.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is an elevational view in axial or vertical cross section of a vibration-damping device in the form of an automobile engine mount of construction according to one preferred embodiment of the invention, taken along line 2-2 of FIG. 1; and

FIG. 2 is a top plane view of an engine mount of FIG. 1.

### DETAILED DESCRIPTION OF PREFERRED EMBODIMENTS

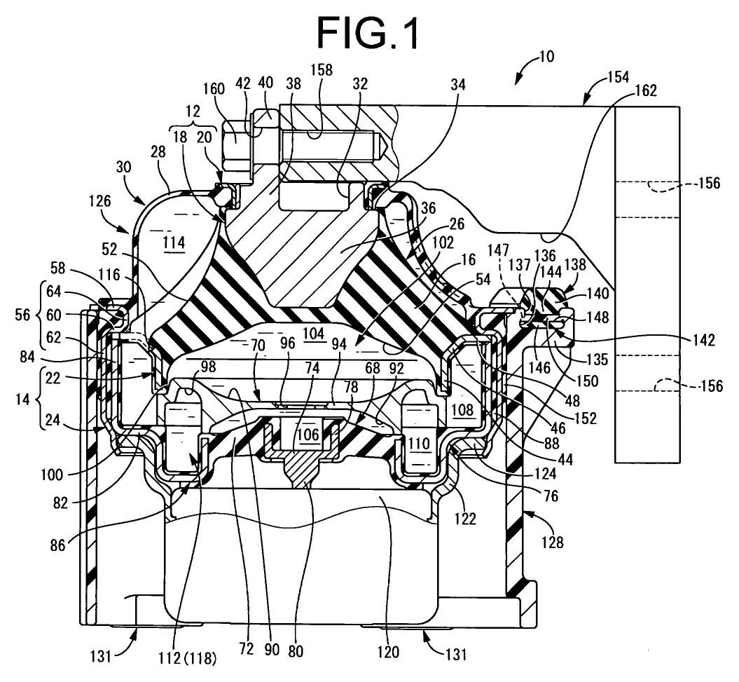

Referring first to FIG. 1, there is shown an automotive engine mount 10 as a first embodiment of a fluid-filled type vibration-damping device of the invention. The engine mount 10 is constructed of a first mounting member 12 of metal and a second mounting member 14 of metal, these being elastically coupled by a main rubber elastic body 16. With the first mounting member 12 attached to the power unit of the vehicle (not shown) and the second mounting member 14 attached to the body of the vehicle (not shown), the power unit is supported on the body in a vibration-damping fashion. In this installed state, the distributed load of the power unit and the principal vibration to be damped are each input across the first mounting member 12 and the second mounting member 14, in the generally axial direction of the engine mount 10 (the vertical direction in FIG. 1). In the description hereinbelow the vertical direction shall as general rule refer to the vertical direction in FIG. 1.

To describe in greater detail, the first mounting member 12 is composed of a main rubber inner fitting 18 and a diaphragm inner fitting 20, while the second mounting member 14 is composed of a main rubber outer tubular fitting 22 and a diaphragm outer tubular fitting 24. The main rubber inner fitting 18 and the main rubber outer tubular fitting 22 are vulcanization bonded to the main rubber elastic body 16, forming a first integrally vulcanization molded component 26. The diaphragm inner fitting 20 and the diaphragm outer tubular fitting 24 are vulcanization bonded to a diaphragm 28 serving as a flexible film, to form a second integrally vulcanization molded component 30, with the first and second integrally vulcanization molded components 26, 30 being assembled to one another.

Here, the main rubber inner fitting 18 constituting part of the first integrally vulcanization molded component 26 has an inverted, generally frustoconical shape; a lightening recess 32 is formed in the generally diametrical central portion of the upper end face (large-diameter end face) of the main rubber inner fitting 18, while the outside peripheral edge of the upper end face constitutes a mating shoulder portion 34 extending all the way around the circumference. Specifically, the lower end of the main rubber inner fitting 18 is constituted as a fastening portion 36 of inverted, generally frustoconical shape, while its upper end is constituted as mating portion 38 of thick, generally disk shape smaller in diameter than the large-diameter end of the fastening portion 36. Additionally, an upwardly projecting mounting plate 40 is integrally formed on the diaphragm inner fitting 20, with a bolt hole 42 being provided in the center portion of the mounting plate 40.

The main rubber outer tubular fitting 22 has a tubular wall portion 44 of generally large-diameter round tubular shape. The axial upper end portion of the tubular wall portion 44 is constituted as a tapered tubular portion 46 that expands gradually going axially upward, and at the upper edge of the tapered tubular portion 46 there is integrally formed a flange shaped portion 48 that expands diametrically outward. The main rubber inner fitting 18 is disposed above and spaced apart from the main rubber outer tubular fitting 22 while positioned on approximately the same center axis therewith, with the inverted tapered outside peripheral face of the fastening portion 36 of the main rubber inner fitting 18 and the inside peripheral face of the tapered tubular portion 46 of the main rubber outer tubular fitting 22 positioned in opposition and spaced apart from one another, and with the opposed faces of the main rubber inner fitting 18 and the main rubber outer tubular fitting 22 elastically connected by means of the main rubber elastic body 16.

The main rubber elastic body 16 has a large-diameter frustoconical shape overall, with a sloped groove 52 extending generally in a straight line in the axial direction being formed on a portion of the tapered outside peripheral face thereof. A conical recess 54 that opens axially downward is formed on the large-diameter end face of the main rubber elastic body 16. The main rubber inner fitting 18 is vulcanization bonded to the central portion of the main rubber elastic body 16 from above in the axial direction and so as to be positioned coaxially therewith. The tapered tubular portion 46 of the main rubber outer tubular fitting 22 is superposed on and vulcanization bonded to the outside peripheral face at the large-diameter end thereof. By means of this design, the main rubber elastic body 16 forms the first integrally vulcanization molded component 26 with the main rubber inner fitting 18 and the main rubber outer tubular fitting 22 described above.

The diaphragm inner fitting 20 that is part of the second integrally vulcanization molded component 30 has a thin disk shape; and the upper end thereof bends outward in the axis-perpendicular direction.

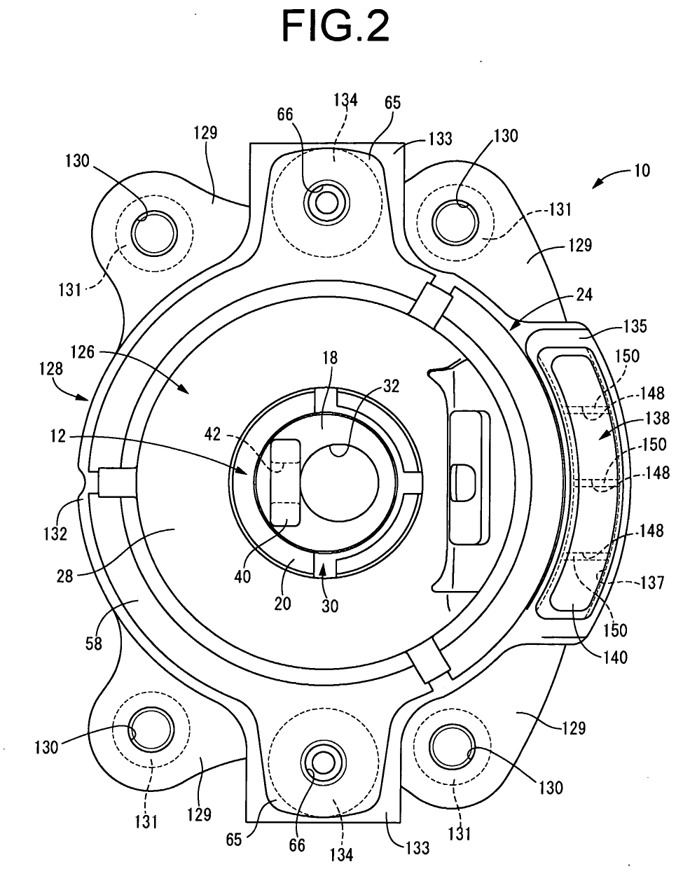

The diaphragm outer tubular fitting 24 includes a tubular portion 56 and an annular support portion 58. The tubular portion 56 is of thin-walled, large-diameter generally round tubular shape, and has a positioning shoulder portion 60 formed on part of the axially medial portion thereof. The positioning shoulder portion 60 is of generally annular shape expanding out in the axis-perpendicular direction. In the tubular portion 56, the section situated axially above the positioning shoulder portion 60 constitutes a large-diameter section 62, while the section situated axially below the positioning shoulder portion 60 constitutes a small-diameter section 64. The large-diameter section 62 is of generally round tubular shape formed extending axially downward from the outside peripheral edge portion of the positioning shoulder portion 60. The small-diameter section 64, on the other hand, is formed extending axially upward from the inside peripheral edge portion of the positioning shoulder portion 60, and has a generally round tubular shape smaller in diameter than the large-diameter section 62. At the axial upper end of the small-diameter section 64, there is integrally formed an annular support portion 58. The annular support portion 58 is of generally disk shape spreading out in the axis-perpendicular direction; as shown in FIG. 2, a pair of mounting flanges 65, 65 that extend out in the diametrical direction are formed on two side portions situated in opposition in one direction across the diameter of the annular support portion 58. The mounting flanges 65, 65 are of generally flat plate shape, and in the generally center portion of each there is formed a fastening bolt hole 66 passing through in the thickness direction.

The diaphragm inner fitting 20 is positioned spaced axially above and on approximately the same center axis with the diaphragm outer tubular fitting 24, with the diaphragm inner fitting 20 and the diaphragm outer tubular fitting 24 being coupled by means of the diaphragm 28.

The diaphragm 28 is formed of thin rubber film, and is of generally annular shape overall, extending in the circumferential direction with a bowed cross section imparted with appreciable slack so as to enable it to readily undergo elastic deformation. The inside peripheral edge of the diaphragm 28 is vulcanization bonded to the outside peripheral edge of the diaphragm inner fitting 20, and the outside peripheral edge of the diaphragm 28 is vulcanization bonded to the opening on the axial upper side of the diaphragm outer tubular fitting 24. By means of this arrangement, the diaphragm 28 is formed as the second integrally vulcanization molded component 30 comprising the diaphragm inner fitting 20 and the diaphragm outer tubular fitting 24.

This second integrally vulcanization molded component 30 is superimposed from above against and assembled with the first integrally vulcanization molded component 26 described previously, fastening the diaphragm inner fitting 20 to the main rubber inner fitting 18 and fastening the diaphragm outer tubular fitting 24 to the main rubber outer tubular fitting 22; additionally, the diaphragm 28 is positioned spaced apart outwardly from the main rubber elastic body 16, so as to cover substantially the entire outside peripheral face of the main rubber elastic body 16.

Specifically, the diaphragm inner fitting 20 is fitted externally onto the mating portion 38 of the main rubber inner fitting 18, positioning them with respect to one another in diametrical direction, while the lower end of the diaphragm inner fitting 20 is superimposed against the mating shoulder portion 34 of the main rubber inner fitting 18, positioning them with respect to one another in axial direction to link and fasten them together. The above arrangement constitutes the first mounting member 12 according to this embodiment, which comprises the main rubber inner fitting 18 and the diaphragm inner fitting 20.

The diaphragm outer tubular fitting 24 is fitted externally onto the main rubber outer tubular fitting 22 from above in the axial direction, positioning them with respect to one another in axial direction by means of juxtaposing the positioning shoulder portion 60 of the diaphragm outer tubular fitting 24 against the flange shaped portion 48 of the main rubber outer tubular fitting 22 from above in the axial direction.

A cover member 68 and a partition plate fitting 70 are assembled to the axially lower side of the first integrally vulcanization molded component 26. The cover member 68 has a support rubber elastic body 72 of generally annular plate shape to the center portion of which is vulcanization bonded an excitation plate 74 constituting a excitation member, and to the outside peripheral portion of which is vulcanization bonded an annular retaining fitting 76, with the excitation plate 74 and the annular retaining fitting 76 being elastically linked by the support rubber elastic body 72.

The excitation plate 74 is of disk shape having integrally formed at its outside peripheral edge an upwardly projecting annular linking portion 78. In the center portion of the excitation plate 74 there is integrally formed a downwardly extending actuating shaft 80 serving as a connector rod. The excitation plate 74, including the annular linking portion 78 and the actuating shaft 80, is integrally formed of rigid material such as metal or synthetic resin.

The annular retaining fitting 76, on the other hand, has an integrally formed tubular fitment portion 84 of generally round tubular shape which projects axially upward from the outside peripheral edge portion of a mounting plate portion 82 of generally annular plate shape, while a grooved portion 86 extending in the circumferential direction a prescribed length short of once around the circumference and opening axially upward is integrally formed on the inside peripheral edge portion of the mounting plate 40. The upper edge of the tubular fitment portion 84 is superimposed against the flange shaped portion 48 of the main rubber outer tubular fitting 22 from axially below, and the annular retaining fitting 76 is positioned in the axial direction relative to the main rubber outer tubular fitting 22.

The excitation plate 74 is positioned inwardly away in the diametrical direction from the annular retaining fitting 76 and on generally the same center axis therewith, and a supporting rubber elastic body 72 is disposed so as to extend between the diametrically opposing faces of the annular retaining fitting 76 and the excitation plate 74. The supporting rubber elastic body 72 is vulcanization bonded at the inside and outside peripheral edges thereof to an annular linking portion 78 of the excitation plate 74 and the grooved portion 86 of the annular retaining fitting 76, with the support rubber elastic body 72 providing fluid-tight closure between the excitation plate 74 and the annular retaining fitting 76. The annular retaining fitting 76 and the excitation plate 74 are covered over generally the entire upper faces and inside peripheral faces thereof by a rubber seal integrally formed with the support rubber elastic body 72. The outside peripheral face of the tubular fitment portion 84 of the annular retaining fitting 76 has a rubber compression insert layer 88 formed covering it, but formed as a separate element from the support rubber elastic body 72.

With the tubular fitment portion 84 of the annular retaining fitting 76 press-fit inserted into the diaphragm outer tubular fitting 24, the cover member 68 is attached so as to provide fluid-tight closure to the opening of the recess 54 in the main rubber elastic body 16. The annular retaining fitting 76 is fastened press-fit into the diaphragm outer tubular fitting 24 by means of the rubber compression insert layer 88 formed covering the outside peripheral face of the tubular fitment portion 84 in the annular retaining fitting 76.

The partition plate fitting 70, on the other hand, has a thick, generally disk shape spreading out in the axis-perpendicular direction, the outside diameter dimension thereof being of a size sufficient to extend as far as the outside peripheral edge of the grooved portion 86 in the annular retaining fitting 76. The outside peripheral portion of the partition plate fitting 70 is superimposed against the upper face of the annular retaining fitting 76, with the partition plate fitting 70 positioned above the cover member 68 on generally the same center axis as the cover member 68. An upper face recess 90 consisting of a large-diameter circular recess is formed in the center portion of the upper face of the partition plate fitting 70 and a lower face recess 92 of generally inverted conical shape is formed in the center portion of the lower face, whereby the diametrical center portion of the partition plate fitting 70 constitutes a thin-walled portion 94. A plurality of orifice holes 96 are formed in the thin-walled portion 94 passing through it in the thickness direction. A cover groove 98 that opens axially downward is formed at the diametrical outside peripheral edge portion of the partition plate fitting 70, so as to extend in the circumferential direction over a distance just short of once around the circumference. At the outside peripheral edge on the upper face of the partition plate fitting 70 there is formed an engaging shoulder portion 100 that extends substantially all the way around the circumference.

The partition plate fitting 70 is superimposed at the outside peripheral portion thereof against the upper face of the annular retaining fitting 76, and the lower edge of the tubular wall portion 44 in the main rubber outer tubular fitting 22 is superimposed in the axial direction against the engaging shoulder portion 100 formed on the upper face of the outside peripheral edge portion of the annular retaining fitting 76, whereby the partition plate fitting 70 extends in the axis-perpendicular direction while sandwiched axially between the annular retaining fitting 76 and the main rubber outer tubular fitting 22. By superimposing the lower edge of the tubular wall portion 44 of the main rubber outer tubular fitting 22 against the engaging shoulder portion 100, the partition plate fitting 70 is fastened positioned in the axial direction with respect to the main rubber outer tubular fitting 22.

By so doing, the lower opening of the diaphragm outer tubular fitting 24 is covered fluidtightly by the cover member 68, thereby forming between the opposing faces of the main rubber elastic body 16 and the cover member 68 a pressure-receiving chamber 102 having a noncompressible fluid sealed therein. A portion of the wall of this pressure-receiving chamber 102 is constituted by the main rubber elastic body 16, and when vibration is input across the first mounting member 12 and the second mounting member 14, vibration is input pressure fluctuations are produced in it on the basis of elastic deformation of the main rubber elastic body 16.

The partition plate fitting 70 is disposed in the pressure-receiving chamber 102, thus dividing the pressure-receiving chamber 102 in two to form on either side of the partition plate fitting 70 a vibration input chamber 104 located on the main rubber elastic body 16 side, and an excitation chamber 106 located on the cover member 68 side, with the vibration input chamber 104 and the excitation chamber 106 communicating via the orifice holes 96.

The main rubber outer tubular fitting 22, the tubular fitment portion 84 of the annular retaining fitting 76, the mounting plate 40 and the partition plate fitting 70 are assembled together fluidtightly via a rubber seal layer, and an outer annular flow channel 108 is formed extending in the circumferential direction a prescribed length short of once around the circumference, while juxtaposing the opening of the cover groove 98 in the partition plate fitting 70 and the grooved portion 86 of the partition plate fitting 70 against one another, thereby forming an inner annular flow channel 110 extending in the circumferential direction a prescribed length short of once around the circumference.

The outer annular flow channel 108 and the inner annular flow channel 110 connect to one another at one end thereof in the circumferential direction, thereby forming an annular flow channel 112 that extends in the circumferential direction a prescribed length equal to twice around the circumference.

The main rubber elastic body 16 and the diaphragm 28 are affixed at their inside peripheral edge and outside peripheral edge respectively to the first mounting member 12 and the second mounting member 14, thereby forming between the opposing faces of the main rubber elastic body 16 and the diaphragm 28 an equilibrium chamber 114 having a noncompressible fluid sealed therein. Specifically, a portion of the wall of the equilibrium chamber 114 is constituted by the readily deformable diaphragm 28, and thereby readily permits change in volume based on elastic deformation of the diaphragm 28. As the non-compressible fluid sealed within the pressure-receiving chamber 102 and the equilibrium chamber 114, it is typically favorable to use a low viscosity fluid of 0.1 Pa·s or lower, in order to efficiently obtain vibration damping based on resonance of fluid caused to flow through the orifice passage 118 (described later), within the vibration frequency range required of the automotive engine mount 10.

The pressure-receiving chamber 102 and the equilibrium chamber 114 formed to the upper side thereof connect with one another by means of the annular flow channel 112 formed within the second mounting member 14, which connects to the pressure-receiving chamber 102 via a through-hole (not shown) formed at a first circumferential end thereof, and connects at the other circumferential end thereof to the equilibrium chamber 114 through a communication window 116 formed in a circumferential portion of the tapered tubular portion 46 of the diaphragm outer tubular fitting 24, thereby forming an orifice passage 118 of prescribed length connecting the pressure-receiving chamber 102 and the equilibrium chamber 114 with one another so as to permit the flow of fluid between the chambers 102, 114. In this embodiment in particular, the orifice passage 118 is tuned by means of appropriately establishing its passage cross sectional area and passage length, so that vibration damping action based of resonance of fluid caused to the flow through it on the basis of a pressure differential created between the pressure-receiving chamber 102 and the equilibrium chamber 114 when vibration is input can be exhibited effectively in the frequency range of engine shake and other such low-frequency, large-amplitude vibration.

On the opposite side of the cover member 68 from the pressure-receiving chamber 102, there is disposed an actuator 120. As the actuator 120, it is possible to use an actuator 120 known in the art, for example, the electromagnetic actuator taught in U.S. Publication No. 2003-0001322 A1 or JP-A-2003-49894; or the pneumatic actuator taught in JP-A-2000-346121 or U.S. Pat. No. 6,679,486. By attaching an actuating shaft 80 to the actuator 120, the excitation of the excitation plate 74 may be actuated in the mounting center axis direction (the vertical in FIG. 1) by means of the actuator 120. The actuator 120 is mounted securely on the second mounting member 14 by means of disposing the flange shaped portion 48 integrally formed at the edge of the opening of its housing 122 of bottomed tubular shape in abutment against the inside peripheral face at the lower end of the diaphragm outer tubular fitting 24, juxtaposing and positioning the flange shaped portion 124 against the mounting plate 40 of the annular retaining fitting 76, and subjecting the diaphragm outer tubular fitting 24 to reduction from all directions or some other diameter-constricting process. The mounting unit 126 of the embodiment is constituted thereby.

A resin bracket 128 serving as the outer bracket is fastened externally fitted onto the mounting unit 126. The resin bracket 128 is formed of rigid resin and has a generally round tubular shape. As depicted in FIG. 2, at the lower axial end of the resin bracket 128 there are formed mounting plate portions 129 as flanged portions of generally plate shape formed so as to extend diametrically outward. A through-hole 130 is formed in the generally center portion of each mounting plate portion 129, so as to pass through it in the axial direction. The mounting plate portion 129 is provided with an embedded mounting nut 131 as a fastener fitting, with the screw hole of the mounting nut 131 being exposed to the outside through the through-hole 130.

At the axial upper end of the resin bracket 128, on the other hand, there is integrally formed an annular flange portion 132 extending around the entire circumference. As depicted in FIG. 2, this annular flange portion 132 is of generally annular plate shape extending out in the axis-perpendicular direction. A pair of bolt embedment portions 133, 133 that extend out in the diametrical direction are formed on two side portions situated in opposition in one direction across the diameter of the annular flange portion 132. These bolt embedment portions 133, 133 are of generally flat plate shape, and each has a fastening bolt 134 implanted therein so as to project upward in the direction of the mounting axis. In this embodiment, the annular flange portion 132 is superimposed against the annular support portion 58 from above in the axial direction, while aligning the through-holes 130 with the bolt embedment portions 133, thereby passing the fastening bolts 134 through the fastening bolt through-holes 66 formed in the diaphragm outer tubular fitting 24. A rebound stopper fitting (not shown) is disposed above the diaphragm outer tubular fitting 22, and mounted onto the diaphragm outer tubular fitting 22 and the resin bracket 128 by means of the fastening bolts 134.

At the upper end of the resin bracket 128, there is formed in a circumferential section thereof a stopper installation portion 135. The stopper installation portion 135 is of generally bowed plate shape extending in the axis-perpendicular direction at an approximately right angle to the diametrical direction in which the pair of bolt embedment portions 133 lie in the resin bracket 128. It extends a prescribed length in the circumferential direction. In this embodiment, the stopper installation portion 135 is of length less than half the circumference of the resin bracket 128, with the stopper installation portion 135 being formed in the diametrical direction at an approximately right angle to the diametrical direction across which the bolt embedment portions 133 lie.

In the stopper installation portion 135 there is also formed an engaging groove 136 is as an engaging recess which opens axially upward. This engaging groove 136 takes the form of a circumferential slot of bottomed groove shape extending in the circumferential direction of the resin bracket 128 on the upper face of the stopper installation portion 135. A constricted retaining portion 137 is formed in proximity to the opening of the engaging groove 136, so that the groove width of the engaging groove 136 in proximity to its opening is narrower than in other portions. The dislodgement preventing portion of this embodiment is constituted thereby.

A portion of a bound rubber stopper 138 serving as a rubber stopper is engaged by the engaging groove 136, with the bound rubber stopper 138 positioned so as to project axially upward in the stopper installation portion 135. The bound rubber stopper 138 is composed so as to include a projecting portion 140 as its distal end portion and an engaged fastener portion 142 as its basal end portion. The projecting portion 140 extends in the circumferential direction with a generally unchanging trapezoidal cross section, and gradually narrows in width going axially upward.

The engaged fastener portion 142, on the other hand, is integrally formed with an abutting portion so as to extend axially downward from the projecting portion 140. The engaged fastener portion 142 has a shape enabling it to be engaged by the engaging groove 136; the bound rubber stopper 138 is fastened to the resin bracket 128 by means of the engaged fastener portion 142 being engaged by the engaging groove 136. To describe in greater detail, the engaged fastener portion 142 has a constricted width portion 144 and an engaging portion 146. The constricted width portion 144 is formed so as to extend axially downward from the lower face of the projecting portion 140, and has a width dimension narrower than the lower end of the projecting portion 140. The engaging portion 146, on the other hand, is formed below the constricted width portion 144, and has a width dimension about equal to that of the lower end of the projecting portion 140. That is, the engaged fastener portion 142 of this embodiment has a shoulder portion 147 in its medial portion in the direction of the mounting axis, with the constricted width portion 144 situated above the shoulder portion 147 having smaller width dimension than the engaging portion 146 situated below the shoulder portion 147.

The bound rubber stopper 138 is attached fitting within the engaging groove 136, mounting the bound rubber stopper 138 onto the resin bracket 128. Additionally, the constricted width portion 144 of the engaged fastener portion 142 is aligned with the constricted retaining portion 137 of the engaging groove 136, and the engaging portion 146 of the engaged fastener portion 142 is positioned axially beneath the constricted retaining portion 137, so that the bound rubber stopper 138 is prevented from becoming dislodged upward in the axial direction of the mounting.

Attachment of the bound rubber stopper 138 to the resin bracket 128 can be accomplished during the process of molding the resin bracket 128, by pre-setting the bound rubber stopper 138 in the mold and then injection molding the resin bracket 128, whereby it is a simple matter to produce a resin bracket 128 having the bound rubber stopper 138 fitting therein as in insert form. Also, by pre-setting the mounting nuts 131 in the mold during the process of molding the resin bracket 128, the mounting nuts 131 can be easily affixed in insert form in the resin bracket 128.

Here, the constricted width portion 144 of the engaged fastener portion 142 in the bound rubber stopper 138 is furnished with a plurality of retaining holes 148 as through-holes which pass through the bound rubber stopper 138 in its generally lateral direction; these retaining holes 148 are filled with resin material during the resin bracket 128 molding process, forming retaining resin elements 150 consisting of retaining resin elements of generally rod shape integrally formed with the resin bracket 128. The bound rubber stopper 138 is penetrated in the lateral direction by these retaining resin elements 150, thereby advantageously preventing the bound rubber stopper 138 from becoming dislodged from the resin bracket 128. In this embodiment in particular, as shown in FIG. 2, three retaining holes 148, 148, 148 are formed parallel to one another, with one retaining resin element 150, 150, 150 passing through each of these retaining holes 148, 148, 148.

The resin bracket 128 formed in this way is mounted fitting externally onto the second mounting member 14. In this embodiment in particular, the second mounting member 14 is fastened press-fit into the resin bracket 128 by means of a mounting rubber layer 152 integrally formed with the diaphragm 28 and covering the outside peripheral face of the diaphragm outer tubular fitting 24 which makes up the second mounting member 14.

The mounting nuts 131 embedded in the mounting plate portions 129 formed at the lower end of the resin bracket 128 are threaded onto mounting bolts (not shown) which are attached to a member on the vehicle body side, thereby attaching the second mounting member 14 to the vehicle body side via the resin bracket 128.

A stopper abutting fitting 154 is affixed as a abutting bracket to the main rubber inner fitting 18. The stopper abutting fitting 154 is of rod or plate shape extending in the axis-perpendicular direction (left to right in FIG. 1); one side thereof in the axis-perpendicular direction (right in FIG. 1) is perforated by a plurality of bolt passage holes 156, while a screw hole 158 is formed in the other side in the axial direction (left in FIG. 1). The stopper abutting fitting 154 is superimposed against the upper face of the main rubber inner fitting 18, and a fastening bolt 160 passed through the mounting plate 40 of the main rubber inner fitting 18 is screwed and fastened in the screw hole 158 of the stopper abutting fitting 154. Thus, the stopper abutting fitting 154 is fastened to the first mounting member 12 and hence to the mounting unit 126, while fastening bolts (not shown) passed through the plurality of bolt passage holes 156 in the other end of the stopper abutting fitting 154 are screwed and fastened to the power unit side, thereby fastening the stopper abutting fitting 154 to the power unit side. With this arrangement, the first mounting member 12 is fixedly mounted onto the power unit side via the stopper abutting fitting 154. In this mounted state, part of the stopper abutting fitting 154 is situated in opposition in the axial direction to the bound rubber stopper 138 which projects axially upward from the resin bracket 128 in the axial direction, so as to constitute a stopper abutting face 162 as an abutting portion. In this embodiment, the stopper abutting face 162 is a generally flat face extending in the axis-perpendicular direction, and is situated spaced apart by a predetermined distance in the axial direction from the bound rubber stopper 138.

By means of this design, the automotive engine mount 10 in this embodiment is disposed affixed to the car power unit and the car body respectively, whereby the power unit is elastically coupled with the car body by means of the engine mount 10.

With the engine mount 10 in the installed state described above, when vibration is input across the first mounting member 12 and the second mounting member 14, flow of fluid through the orifice passage 118 is produced on the basis of the pressure differential between the pressure-receiving chamber 102 and the equilibrium chamber 114 occurring in association with elastic deformation of the main rubber elastic body 16, and on the basis of resonance or other flow action of the fluid, passive vibration damping action is attained. Additionally, by means of exciting actuation of the excitation plate 74 with the actuator 120 depending on the vibration to be damped, pressure fluctuations are exerted from the excitation chamber 106 to the vibration input chamber 104 through the orifice holes 96, whereby dynamic vibration damping of input vibration can be attained through dynamic control of pressure fluctuations in the vibration input chamber 104.

When excessive load is exerted in the direction of principal vibration input of the automotive engine mount 10, and more specifically in the bound direction which is the direction in which the first mounting member 12 and the second mounting member 14 come into closer proximity with one another, the stopper abutting face 162 of the stopper abutting fitting 154 affixed to the first mounting member 12 comes into abutment with the stopper installation portion 135 of the resin bracket 128 via the bound rubber stopper 138, thereby restricting in a cushioned manner the extent of displacement of the first mounting member 12 and the second mounting member 14 in the direction of proximity with one another. As will be apparent from this, the stopper mechanism which pertains to the automotive engine mount 10 of this embodiment is constituted as a bound stopper mechanism which includes the stopper abutting fitting 154, the resin bracket 128, and the bound rubber stopper 138. It will also be apparent from the preceding description that in this embodiment the stopper mechanism is formed on a circumferential section of the mounting unit 126.

In the automotive engine mount 10 constructed according to this embodiment, the bound rubber stopper 138 can be easily attached to the resin bracket 128 without the use of special fittings for doing so. Consequently, the number of parts can be reduced and the assembly procedure can be simplified as compared to the case where special fastening means are employed, and a stopper mechanism can be achieved advantageously.

Moreover, in addition to the mating action of the engaged fastener portion 142 in the bound rubber stopper 138 with the engaging groove 136 in the resin bracket 128, the retaining resin elements 150 integrally formed with the resin bracket 128 pass through the retaining holes 148 formed in the bound rubber stopper 138, whereby a bound stopper mechanism furnished with high reliability can be achieved. That is, in the event that excessive load is exerted in the bound direction causing the bound rubber stopper 138 to strike against the stopper abutting fitting 154 so that the bound rubber stopper 138 is subjected to the action of external force in a direction other than the axial direction, the bound rubber stopper 138 will nevertheless be advantageously prevented from becoming dislodged, due to the retaining resin elements 150 integrally formed with the resin bracket 128, and the bound rubber stopper 138 will be able to consistently maintain its initial state of attachment when subjected to such load.

Also, by pre-setting the mounting nuts 131 in the mold during molding of the resin bracket 128, so that the mounting nuts 131 are attached by being embedded within the resin bracket 128, the engine mount 10 can be easily mounted on the car body side simply be means of threading mounting bolts (not shown) into the mounting nuts 131, and productivity can be improved.

By employing the bracket formed of resin material, i.e. the resin bracket 128, the bracket will easily break due to excessive impact force in the event of a car crash or the like. Consequently, there is less danger that during collision the engine mount will not break and strike a pedestrian, so that improved safety in the event of a collision can be improved.

While the invention has been described hereinabove in terms of certain preferred embodiments, it is not limited thereto, and the invention should in no wise be interpreted as limited to the specific disclosure of the embodiments herein.

For instance, whereas in the embodiments hereinabove, there is described an example wherein, in consideration of ease of filling with resin and other considerations, the retaining holes 148 formed in the bound rubber stopper 138 and the retaining resin elements 150 integrally formed with the resin bracket 128 and passing through the retaining holes 148 are all formed so as to extend perpendicular to the axial direction of the mounting, which is the lateral direction of the bound rubber stopper 138. However, the direction of extension of the retaining holes 148 and the retaining resin elements 150 is not limited in any way to that taught in the embodiments hereinabove. Specifically, the retaining holes 148 and the retaining resin elements 150 may be formed so as to extend in the circumferential direction of the mounting, which is the lengthwise direction of the bound rubber stopper 138. Nor are the number of retaining holes 148 and retaining resin elements 150 limited to those specifically taught in the embodiments hereinabove, and these may be selected appropriately.

The shape of the projecting portion 140 in the bound rubber stopper 138 is not limited in any way to that taught in the embodiments hereinabove. Nor is the shape of the engaged fastener portion 142 in the bound rubber stopper 138 limited in any way to that taught in the embodiments hereinabove, provided that its shape can engage with the engaging groove 136.

Also, whereas the embodiments hereinabove describe the example of a dynamic vibration damping device equipped with an actuator 120, such an actuator 120 is not always necessary; the invention could instead be implemented in an engine mount lacking an excitation plate 74 and an actuator 120, and producing only passive vibration damping action.

Further, whereas the embodiments hereinabove describe the example of a sealed fluid type vibration damping device having a pressure-receiving chamber 102 and an equilibrium chamber 114, with a noncompressible fluid being sealed in the chambers 102, 114 and the chambers 102, 114 communicating with one another through the orifice passage 118, with the resonance action of fluid caused to flow through the orifice passage 118 being used [for vibration damping], the vibration damping device need not necessarily be of sealed fluid design; the invention could instead be implemented in a vibration damping device that exhibits vibration damping action through elastic force of the main rubber elastic body 16.

While detail citations are omitted, it is to be understood that the invention is by no means limited to the details of the illustrated embodiment, but may be otherwise embodied. It is also to be understood that the present invention may be embodied with various changes, modifications and improvements which may occur to those skilled in the art, without departing from the spirit and scope of the invention.

What is claimed is:

1. A vibration-damping device for elastically connecting two components in a vibration damping fashion, said device comprising:
a first mounting member fixable to one of the two components;
a second mounting member of generally tubular shape fixable to an other of the two components, the first mounting member being disposed spaced apart from a first open end of the second mounting member;
a main rubber elastic body elastically connecting the first and second mounting members together;
an outer bracket of generally tubular shape fastened fitting externally onto said second mounting member so that the second mounting member is mounted via said outer bracket onto the other of the two components, the outer bracket comprising a resin bracket fabricated of synthetic resin that includes: an engaging recess at a first axial end portion thereof; an integrally formed flange portion at an other axial end portion thereof with a fastener fitting for fastening the resin bracket to the second mounting member being fastened inserted within said flange portion; and a retaining resin element integrally formed therewith; and
a rubber stopper having a through-hole formed in a basal end portion thereof and supported by means of said engaging recess of the resin bracket,
wherein an inside width dimension of the engaging recess is wider at a bottom side portion than an opening portion so that the basal end portion of the rubber stopper fits inserted within said engaging recess, and the through-hole in the basal end portion of the rubber stopper is filled with the retaining resin element.

2. A vibration-damping device according to claim 1, wherein said engaging recess is constituted by a circumferential slot that extends a prescribed length in a circumferential direction of said resin bracket; said rubber stopper has an elongated shape extending in a circumferential direction corresponding to said circumferential slot; and said through-hole and said retaining resin element are formed so as to extend in a width direction of said circumferential slot.

3. A vibration-damping device according to claim 1, wherein a plurality of said through-holes and said retaining resin elements are formed in said engaging recess and said rubber stopper.

4. A vibration-damping device according to claim 1, further comprising an abutting bracket fastened to said first mounting member and extending out in an axis-perpendicular direction, wherein said first mounting member is mounted via said abutting bracket onto one of said two components, said abutting bracket having an abutting portion situated spaced apart in axial opposition with respect to the other axial end portion of said resin bracket; and said abutting portion of said abutting bracket has a bound stopper function by means of striking against said resin bracket in an axial direction via said rubber stopper.

5. A vibration-damping device according to claim 1, wherein a vicinity of the opening of the engaging recess formed in the resin bracket constitutes a dislodgment preventing portion of constricted width; and said engaging portion of said rubber stopper has a shoulder portion that engages with said dislodgment preventing portion of said engaging recess.

6. A vibration-damping device according to claim 1, further comprising a pressure receiving chamber whose wall is partially constituted by said main rubber elastic body and adapted to give rise to pressure fluctuations when vibration is input; and an equilibrium chamber whose wall is partially constituted by a readily elastically deformable flexible film and adapted to permit change in volume when vibration is input, wherein a noncompressible fluid is sealed within said pressure receiving chamber and said equilibrium chamber, and an orifice passage is formed connecting said pressure receiving chamber and equilibrium chamber together, the device exhibiting vibration damping action on the basis of flow action of fluid through said orifice passage.

7. A vibration-damping device according to claim 6, further comprising an excitation mechanism for exerting excitation force on said pressure receiving chamber.
